(19) United States
(12) Patent Application Publication
(10) Pub. No.: US 2007/0183297 A1
(43) Pub. Date: Aug. 9, 2007

(54) Compositive wave plate

(75) Inventor: Masayuki Ooto, Kouza-gun (JP)

Correspondence Address: KODA & ANDROLIA, 2029 CENTURY PARK EAST, SUITE 1140, LOS ANGELES, CA, 90067, US

(73) Assignee: Toyo Communication Equipment Co., Ltd.

(21) Appl. No.: 10/825,805

(22) Filed: Apr. 15, 2004

(30) Foreign Application Priority Data
Apr. 16, 2003 (JP) 2003-111083

(51) Int. Cl. G11B 7/00

(52) U.S. Cl. 369/112.16; 369/112.01

(57) ABSTRACT

The invention is intended to solve the problem of a phase shift by the incidence angle dependence of a composite wave plate which is caused when divergent light is incident directly thereon because of occurrence of a phase shift in addition to a desired phase difference of the composite wave plate. The composite wave plate is composed of two laminated wave plates, and respective parameters are set such that: letting θ1 represent the azimuth angle of the optical axis of the first wave plate with respect to the plane of polarization of incident light thereon in the Poincare sphere representation, θ2 represent the azimuth angle of the optical axis of the second wave plate with respect to the plane of polarization of incident light thereon in the Poincare sphere representation, Γ1 represent a phase rotation about the axis of rotation R1 of the first wave plate in the Poincare sphere representation, and Γ2 represent a phase rotation about the axis of rotation R2 of the second wave plate in the Poincare sphere representation,
θ2−θ1≠π/2; and that a phase difference ΓT of the composite wave plate satisfies
ΓT=(2×θ1−π/2)cos Γ1+(2×θ2−π)cos Γ2.

### BACKGROUND OF THE INVENTION

1. Field of the Invention

The present invention relates to a wave plate for use in an optical head or similar optical device that projects a light spot onto a CD, DVD, or similar disk-shaped storage medium to record thereon information or reproduce therefrom recorded information and, more particularly, to a wave plate of improved dependence on the angle of incidence thereon of divergent light, and an optical head using the wave plate.

2. Background Art

An optical disk recording and reproducing apparatus that uses laser light to record information on and reproduce information from a CD, DVD, or similar disk-shaped storage medium is provided with an optical head device that projects a spot of laser light emitted from a laser light source onto the data-bearing surface of the storage medium to record thereon information and reproduce therefrom information.

As is well-known in the art, the optical head device has a semiconductor laser element (a laser diode, which will hereinafter be referred to as LD) as a light emitting element of the laser light source and a photodetector (a photodiode, which will hereinafter be referred to as PD) as a light receiving element; at the time of driving the LD, to keep constant the output of the laser light that is emitted from the LD, it is necessary to receive a portion of the laser light by the photodetector for monitoring use and control the intensity of laser light by an APC (Auto Power Control) circuit.

A conventional read-only optical head for the optical disk is typically configured to monitor the output light that is emitted from the rear end face of the LD, but in a recording type optical head device requires more tight control of the laser light. A recording type optical head device is customary to adopt what is called a front monitor system that monitors a portion of the laser light emitted from the front end face of the LD and feeds back the monitored output to an LD drive circuit to control the intensity of the laser light to thereby exclude the influence of back-talk noise (light source noise) and emit the laser light with an extremely stabilized intensity.

A typical front monitor system is such as shown in FIG. 7, in which, as described in Japanese Laid-open Application Publication No. 2000-348371, divergent light 2 emitted as S-polarized light from LD1 is rendered by a collimator lens (a cylindrical lens) into parallel rays for incidence on a composite wave plate 2, from which they are emitted as elliptically polarized light for incidence on a beam splitter (hereinafter referred to as PBS) 3, wherein S-polarized light components are reflected by a reflecting interface 4 and focused by an objective lens at a pit of an optical disk, whereas P-polarized light components pass through the above-mentioned reflecting interface 4 and are focused by a condenser lens 5 at a light receiving element 6 of the front monitor to control the laser light that is emitted from LD1. The quantity of laser light that is detected by the front monitor is usually controlled by adjusting the transmittance of light passing through the reflecting interface of the above-mentioned PBS3, and the transmission factor of the PBS3 is set about 10%.

In the optical head device of such a configuration as depicted in FIG. 7, however, the distance from LD1 to the light receiving element 6 of the front monitor is long, constituting an obstacle to miniaturization of the optical head device.

Faced with the problem how to reduce the distance from LD to the front monitor, the inventor of this application hit upon a configuration that does away with the collimator lens interposed between the LD and the wave plate and the condenser lens interposed between the PBS and the front monitor, that is, such a layout of the optical head device as described below.

As shown in FIG. 8, divergent light emitted as P-polarized light from the LD is rendered into elliptically polarized light by the composite wave plate 2 which puts the incident light 37° out of phase, then the elliptically polarized light impinges on the PBS, then S-polarized light components of the elliptically polarized light are reflected by the reflecting interface 4 of the PBS to pass through the collimator lens and focused by the objective lens at the pit of the optical disk, and the P-polarized light components pass through the reflecting interface 4 and are focused by the condenser lens 5 at the light receiving element 6 of the front monitor.

However, the composite wave plate 2 has such a structure wherein first and second wave plates are laminated in this order in the direction of incidence of the divergent light as shown in FIG. 9(b) with their optical axes crossing at right angles to each other as depicted in FIG. 9(a); it was found out that when linearly polarized light emitted from the LD1 impinges on the composite wave plate 2 as shown in FIG. 10, the transmittance of the P-polarized light greatly varies through optical operation based on the relationship between the direction of the optical axis of the first wave plate and the angle of incidence thereon as depicted in FIG. 11.

FIG. 12 is a diagram for explaining the optical operation of the composite wave plate, using a Poincare sphere. As is well-known, the Poincare sphere represents the state of polarization of light by points on a spherical surface.

Linearly polarized light incident on the composite wave plate from the direction of an S1 axis on the equator turns Γ1 about a rotational axis R1 of the first wave plate and then turns Γ2 in the opposite direction about a rotational axis R2 of the second wave plate, thereafter being emitted as elliptically polarized light.

Accordingly, since the desired phase difference by the composite plate is added with a further phase shift, direct incidence of divergent light on the composite wave plate presents a problem of the phase shift by the incidence angle dependence.

The present invention is intended to solve the above-mentioned problem, and has for its object to provide a composite wave plate of greatly improved incidence angle dependence.

### SUMMARY OF THE INVENTION

To solve the above-described problem, the invention recited in claim 1 is a composite wave plate formed by two laminated wave plates, which is characterized in that, letting θ1 represent the azimuth angle of the optical axis of the first wave plate with respect to the plane of polarization of incident light thereon in the Poincare sphere representation, θ2 represent the azimuth angle of the optical axis of the second wave plate with respect to the plane of polarization of incident light thereon in the Poincare sphere representation, Γ1 represent a phase rotation about the axis of rotation R1 of the first wave plate in the Poincare sphere representation, and Γ2 represent a phase rotation about the axis of rotation R2 of the second wave plate in the Poincare sphere representation,
θ2−θ1≠π/2
and that a phase difference ΓT of the composite wave plate satisfies
ΓT=(2×θ1−π/2)cos Γ1+(2×θ2−π)cos Γ2.

### BRIEF DESCRIPTION OF THE DRAWINGS

FIG. 1 shows a composite wave plate according to a first embodiment of the present invention, (a) being its plan view and (b) a table showing its parameters.

FIG. 2 shows the incidence angle dependence of the composite wave plate according to the first embodiment of the present invention.

FIG. 3 shows a composite wave plate according to a second embodiment of the present invention, (a) being its plan view and (b) a table showing its parameters.

FIG. 4 shows the incidence angle dependence of the composite wave plate according to the second embodiment of the present invention.

FIG. 5 is a plan view of the composite wave plate according to the present invention.

FIG. 6 is a diagram for explaining the optical operation of the composite wave plate according to the present invention, using a Poincare sphere.

FIG. 7 is a diagram showing a conventional optical head device.

FIG. 8 is a diagram showing an optical head device.

FIG. 9 shows a conventional composite wave plate, (a) being its plan view and (b) a perspective view of wave plate to be laminated.

FIG. 10 is a plan view showing the relationship between the incidence angle and optical axis of divergent light on a conventional composite wave plate.

FIG. 11 shows the incidence angle dependence of the conventional composite wave plate.

FIG. 12 is a diagram for explaining the optical operation of the conventional composite wave plate, using a Poincare sphere.

### DETAILED DESCRIPTION OF THE PREFERRED EMBODIMENTS

The present invention will be described below in detail with reference to its embodiments depicted in the accompanying drawings.

After having studied over and over again, the inventor of this application has arrived at a conclusion that it would be possible to implement a composite wave plate of a structure in which no further phase shift from the desired phase difference occurs even if divergent light impinges on the composite wave plate, by laminating wave plates so that their optical axes do not cross at right angles, and by setting the phase rotation angle (a phase difference) of each wave plates and the azimuth angle of its optical axis (hereinafter referred to as an azimuth angle) with respect to the plane of polarization of incident light so that the phase difference resulting from the relationship between the optical axis of each wave plate and the incidence angle of divergent light thereon is cancelled.

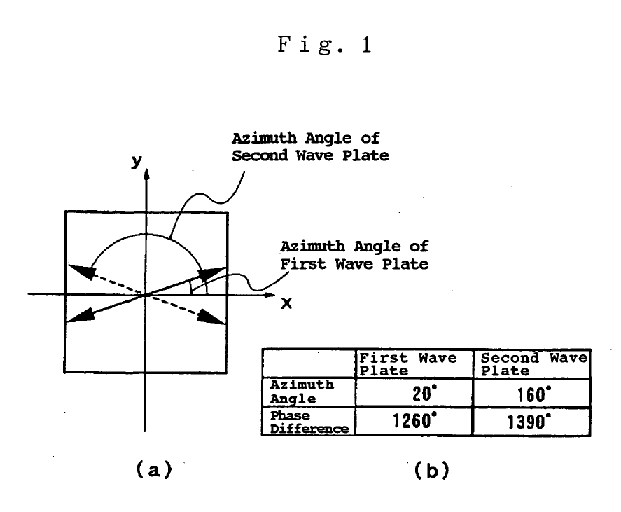

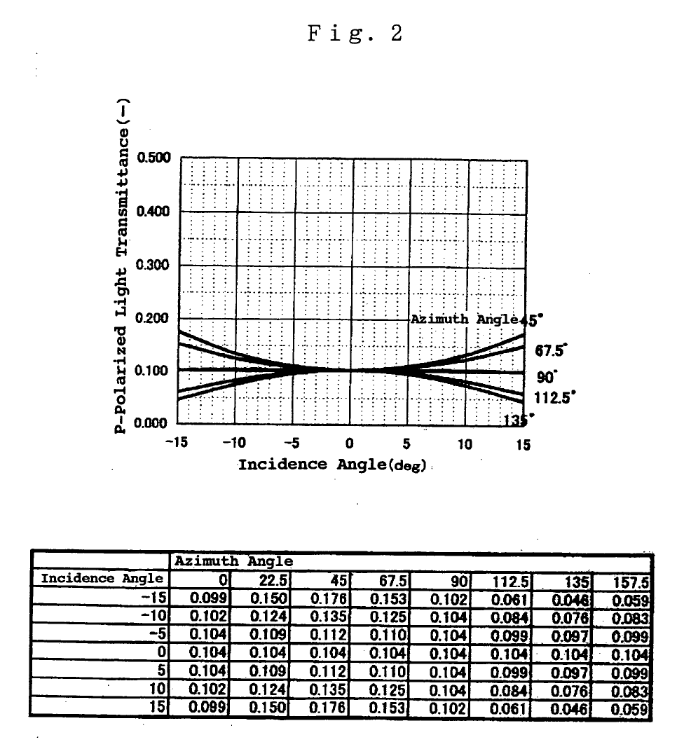

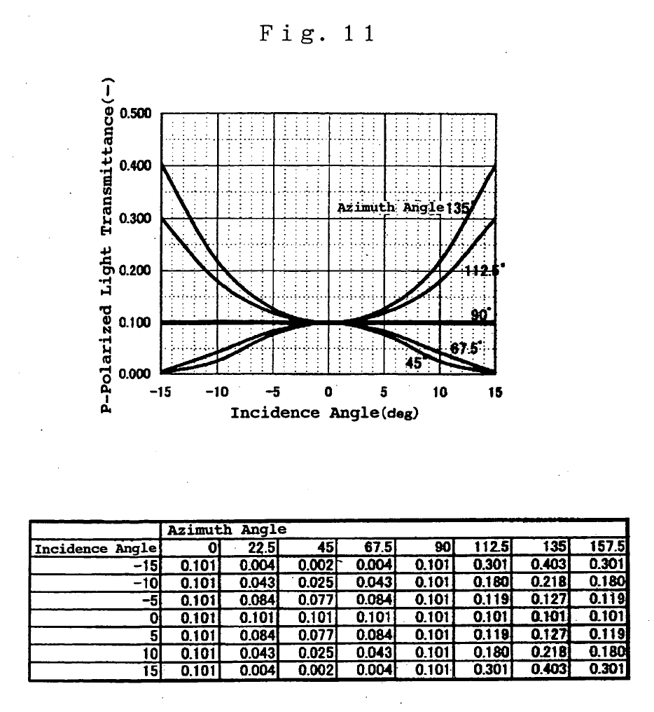

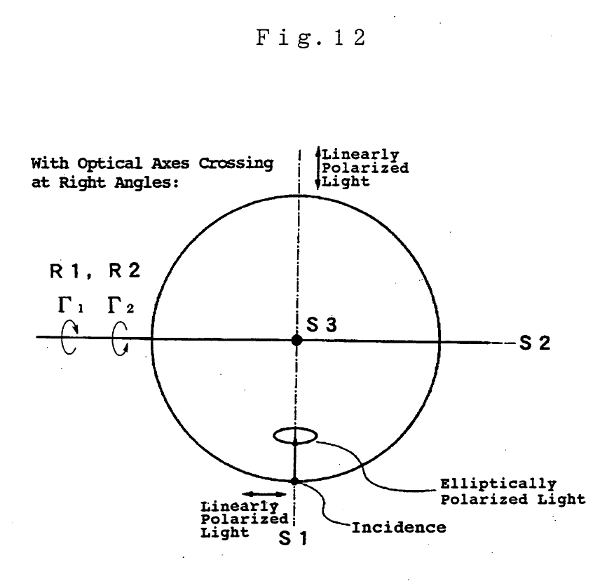

FIG. 1 illustrates the structure of a composite wave plate according to a first embodiment of the present invention, FIG. 1(a) being a plan view of the composite wave plate as viewed from the direction of incidence of light thereon, and FIG. 1(b) being a table showing the differences in the azimuth angle and phase between the first and second wave plates to be laminated. FIG. 2 shows the dependence of the composite wave plate on incidence angle, from which it can be seen that variations in the transmittance of the P-polarized light with the incidence angle of divergent light has been sharply improved as compared with the incidence angle dependence in the prior art described in FIG. 11.

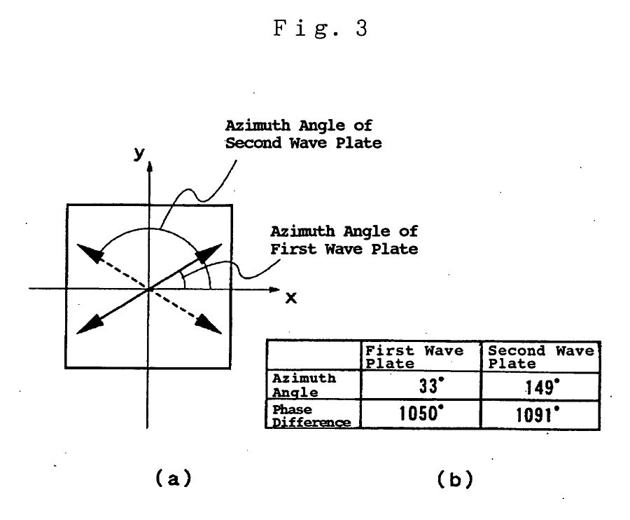

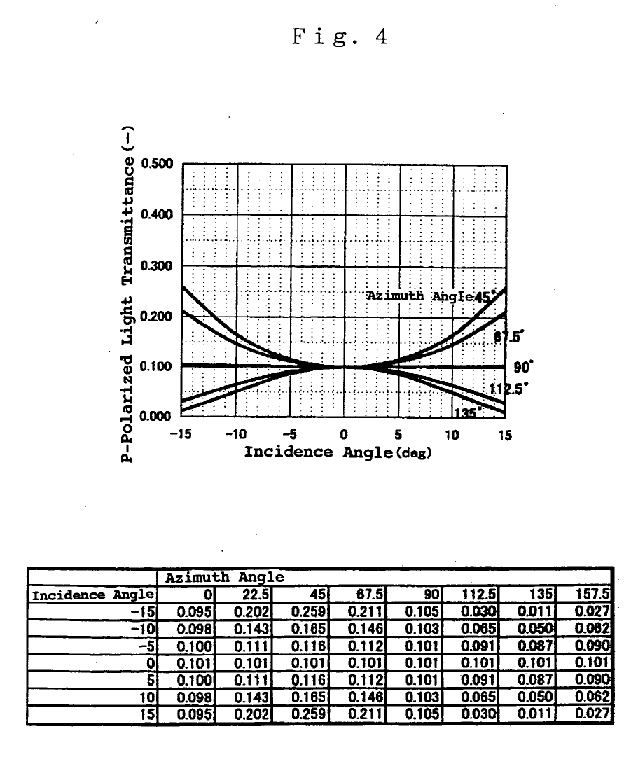

FIG. 3 illustrates the structure of a composite wave plate according to a second embodiment of the present invention, FIG. 3(a) being a plan view of the composite wave plate as viewed from the direction of incidence of light thereon, and FIG. 3(b) being a table showing the differences in the azimuth angle and phase between the first and second wave plates to be laminated. FIG. 4 shows the dependence of the composite wave plate on incidence angle, from which it can be seen that variations in the transmittance of the P-polarized light with the incidence angle of divergent light has been sharply improved as compared with the incidence angle dependence in the prior art described in FIG. 11.

The inventor of this application hit upon an idea that he composite wave plates of the first and second embodiment of the present invention could be computed by mathematical calculations based on the conditional expression described below.

Next, the optical operation of the composite wave plate according to the present invention will be described using a Poincare sphere.

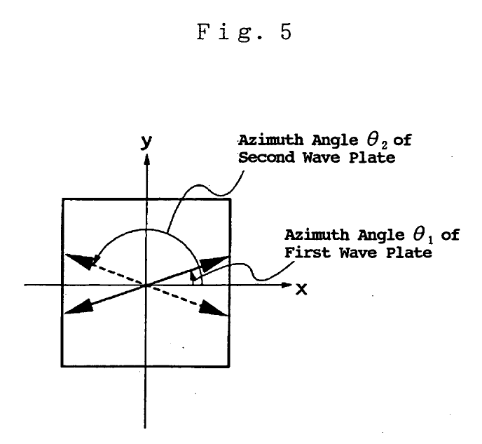

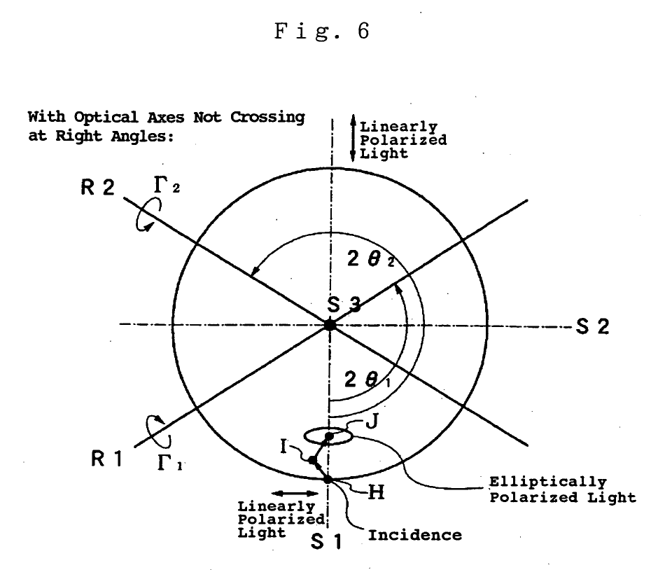

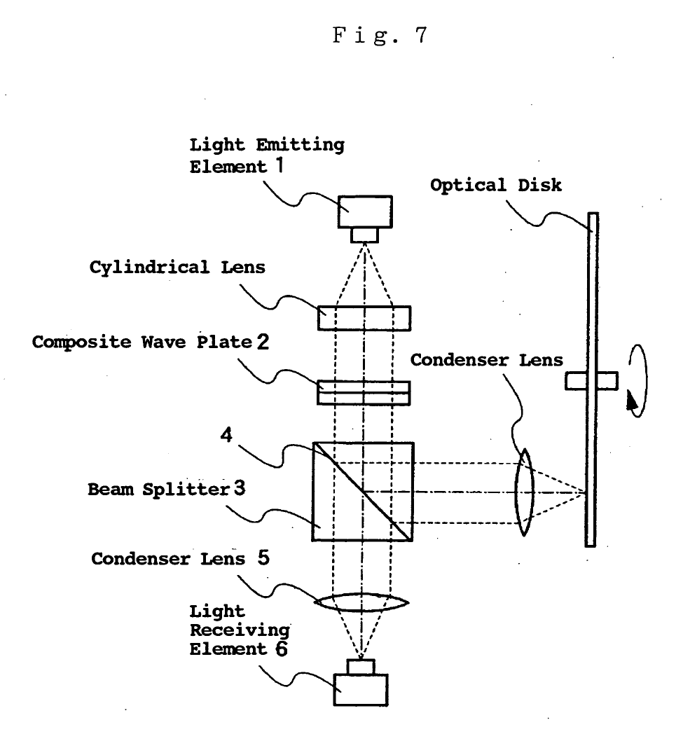

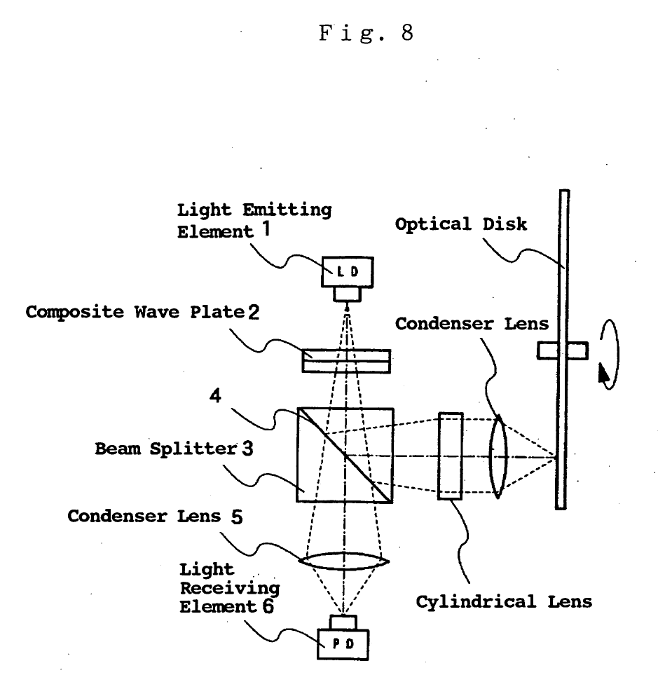

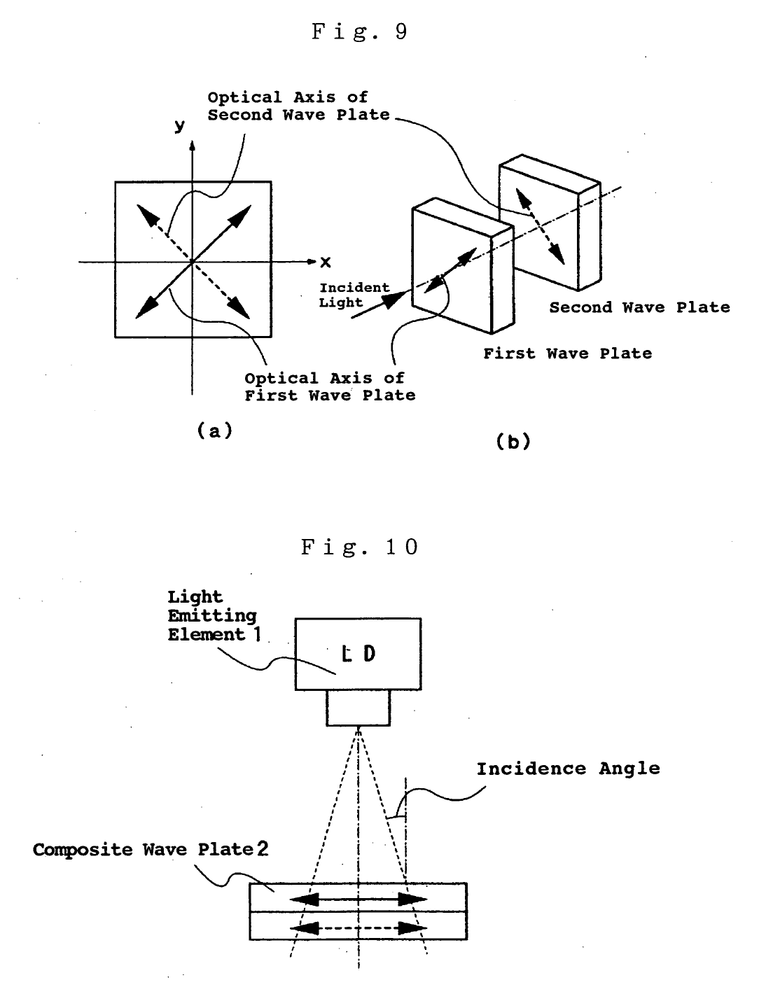

The incidence angle dependence of the composite wave plate formed by two laminated wave plates could sharply be improved by setting respective parameters such that, letting θ1 represent the azimuth angle of the optical axis of the first wave plate with respect to the plane of polarization of incident light thereon in the Poincare sphere representation and θ2 represent the azimuth angle of the optical axis of the second wave plate with respect to the plane of polarization of incident light thereon in the Poincare sphere representation as shown in FIG. 5, and letting Γ1 represent a phase rotation about the axis of rotation R1 of the first wave plate in the Poincare sphere representation and Γ2 represent a phase rotation about the axis of rotation R2 of the second wave plate in the Poincare sphere representation as shown in FIG. 6,
θ2−θ1≠π/2
and that a phase difference ΓT of the composite wave plate satisfies
ΓT=(2×θ1−π/2)cos Γ1+(2×θ2−π)cos Γ2.
FIG. 6 shows the projection of the Poincare sphere from the North Pole S3.

When linearly polarized light is incident on the first wave plate at a point H on an S1 axis on the equator, it rotates Γ1 about the axis of rotation R1 of the first wave plate and shifts to a point I on the surface of the Poincare sphere, then rotates Γ2 about the axis of rotation R2 of the second wave plate, and reaches a point J on the surface of the Poincare sphere, thereafter being emitting as elliptically polarized light.

As described above, the present invention produces such an excellent effect as mentioned below.

The invention recited in claim 1 brings about a fine effect of greatly improving the incidence angle dependence of the composite wave plate composed of two laminated wave plates since respective parameters are set such that, letting θ1 represent the azimuth angle of the optical axis of the first wave plate with respect to the plane of polarization of incident light thereon in the Poincare sphere representation, θ2 represent the azimuth angle of the optical axis of the second wave plate with respect to the plane of polarization of incident light thereon in the Poincare sphere representation, Γ1 represent a phase rotation about a rotational axis R1 of the first wave plate in the Poincare sphere representation, and Γ2 represent a phase rotation about a rotational axis R2 of the second wave plate in the Poincare sphere representation,
θ2−θ1≠π/2
and that a phase difference ΓT of the composite wave plate satisfies
ΓT=(2×θ1−π/2)cos Γ1+(2×θ2−π)cos Γ2.

Furthermore, the use of the composite wave plate of the present invention in an optical head device permits reduction of the number of parts and hence miniaturization of the optical head device.

What is claimed is:

1. A composite wave plate composed of two laminated wave plates, characterized in that:
letting θ1 represent the azimuth angle of the optical axis of the first wave plate with respect to the plane of polarization of incident light thereon in the Poincare sphere representation, θ2 represent the azimuth angle of the optical axis of the second wave plate with respect to the plane of polarization of incident light thereon in the Poincare sphere representation, Γl represent a phase rotation about the axis of rotation R1 of the first wave plate in the Poincare sphere representation, and Γ2 represent a phase rotation about the axis of rotation R2 of the second wave plate in the Poincare sphere representation,
θ2−θ1≠π/2
and that a phase difference ΓT of the composite wave plate satisfies
ΓT=(2×θ1−π/2)cos Γ1+(2×θ2−π)cos Γ2.
